(19) United States
(12) Patent Application Publication
(10) Pub. No.: US 2019/0267909 A1
(43) Pub. Date: Aug. 29, 2019

(54) ENERGY DISTRIBUTION APPARATUS, SYSTEM AND METHOD THEREOF

(71) Applicant: Virelec Ltd., Oakville (CA)

(72) Inventor: Douglas Urban, Brampton (CA)

(21) Appl. No.: 16/284,672

(22) Filed: Feb. 25, 2019

Related U.S. Application Data
(60) Provisional application No. 62/634,364, filed on Feb. 23, 2018.

(51) Int. Cl. H02M 5/42; H02J 3/00; H02M 5/12; H02J 7/04

(52) U.S. Cl. CPC H02M 5/42; H02J 7/04; H02M 5/12; H02J 3/00

(57) ABSTRACT

An apparatus, method and system are provided for use with (i) a three phase transmission line adapted for unbalanced loads leading to (ii) an alternating current (AC) grid in a geographically remote location, and intended to deliver energy having predefined qualities. The apparatus includes an AC-DC converter system operatively coupled to the transmission line, which is adapted to receive input AC power having one or more phases delivered by the transmission line and configured to convert the input AC power into direct current (DC) power. The apparatus further includes a DC bus and battery adapted to receive and store DC power from the AC-DC converter and a DC-AC converter system operatively coupled to receive power from, the AC-DC converter system or the battery, to convert said received power into AC power having the predefined qualities and adapted to deliver the AC power to the remote AC grid.

### CROSS REFERENCE TO RELATED APPLICATIONS

This Application claims the benefit of U.S. Provisional Application 62/634,364 filed on Feb. 23, 2018.

### TECHNICAL FIELD

The present invention relates to transmission line systems and the transfer of reliable power in geographically remote locations.

### BACKGROUND

Long transmission lines typically involve numerous poles and insulators, among other components, each potentially being a point of failure in inclement weather, when lightning strikes, from other sources of interference or due to general equipment failure. Unreliability is generally understood to be proportional to the length of the transmission line, and proportional to the number of individual components that have to be in working order.

Three phase power lines are known to be cost efficient and flexible systems for transmitting energy. However, they typically require that all three phases be in working order for the energy to be useful. In that regard, transmission line systems are often designed so that even if one insulator on one phase fails, for example, the entire line shuts down. As such, transferring reliable, high quality power and the correct voltage over long transmission lines can be very difficult to accomplish.

Previous attempts to alleviate these issues include:

Redundant Lines: where an additional line is added so that the loss of a single line does not affect the larger system. However, this is not affordable for remote communities, mines or other remote industries.

High Performance Lines: the use of super insulation, increased conductor spacing, and provision of surge protection help to reduce the frequency of failure due to weather or lightning. However, failure in any one line or phase is still possible, and the consequence of the entire line shutting down does not change.

Line Reactive Compensation: There is an array of fixed and active reactive compensation tools including series capacitors, shunt reactors, Static VAR Compensators, and voltage regulators aimed at ensuring the presence of “useful” voltages at the load end of long lines. While these tools offset the voltage problems long lines create but have no positive effect on reliability.

Single Phase Tripping and Reclosing: This was recently attempted on a 287 kV radial line with very limited success. This solution attempted to address the inevitable high frequency of single phase lightning induced line outages.

High Voltage Direct Current (HVdc) Lines: This solution decouples energy transfer and “qualities” as the energy is transferred through redundant DC lines and the energy is made useful, using Converter Stations that create AC of appropriate voltage, phase and frequency. However, HVdc is expensive and mid line taps are usually prohibitively expensive.

### SUMMARY

This disclosure provides an apparatus for use with (i) a three phase transmission line adapted for unbalanced loads leading to (ii) an alternating current (AC) grid in a geographically remote location, and intended to deliver energy having predefined qualities. The apparatus includes an AC-DC converter system operatively coupled to the transmission line, which is adapted to receive input AC power having one or more phases delivered by the transmission line and configured to convert the input AC power into direct current (DC) power. The apparatus further includes a DC bus and battery adapted to receive and store DC power from the AC-DC converter and a DC-AC converter system operatively coupled to, and adapted to receive power from, the AC-DC converter system or the battery, to convert said received power into AC power having the predefined qualities and adapted to deliver the AC power having the predefined qualities to the remote AC grid.

This disclosure further provides a system for use with (i) a three phase transmission line leading to (ii) an alternating current (AC) grid in a geographically remote location, the AC grid intended to deliver energy having predefined qualities, where the system includes an apparatus as described above, and a source for operative coupling to the transmission line upstream of the apparatus, the source capable of delivering unbalanced loads.

This disclosure further provides a method of distributing energy having predetermined qualities in a geographically remote location from a three phase transmission line to a remote AC grid. The method includes receiving input AC power having up to three phases from the transmission line, converting the input AC power into DC power, converting the DC power into output AC power having predefined qualities, and sending the AC power having the predefined qualities to the remote AC grid.

Advantages and features of the invention will become evident upon a review of the following detailed description and the appended drawings, the latter being briefly described hereinafter.

### BRIEF DESCRIPTION OF THE DRAWINGS

Reference will now be made, by way of example, to the accompanying drawings which show an example embodiment of the present application, in which:

FIG. 1 is a schematic diagram of an apparatus and a system according to example embodiments of the present invention, and

FIG. 2 is a flow diagram of a method according to an example embedment of the present invention.

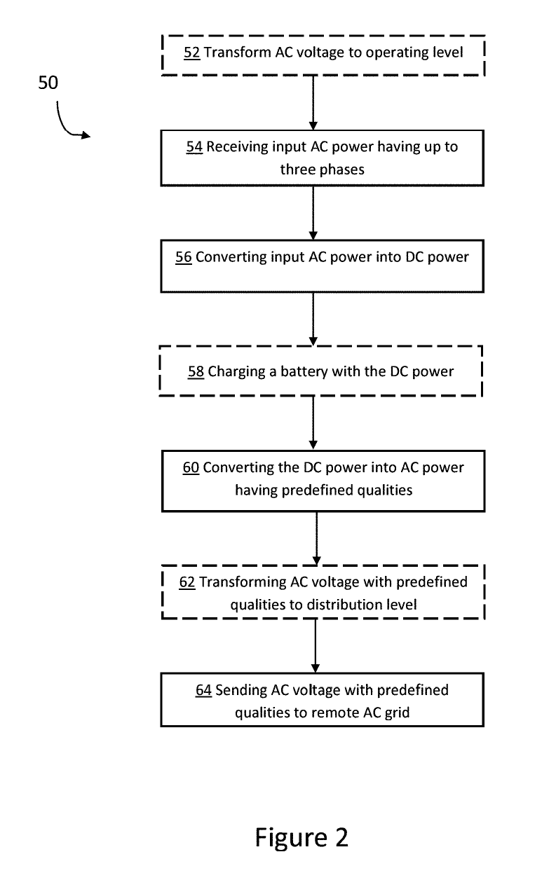

### DETAILED DESCRIPTION OF EMBODIMENTS

The present invention can be viewed as a “hybrid” of AC and DC transmission that converts incoming voltages to direct current (DC) and reconverts the DC back into high quality, three phase alternating current (AC). Example embodiments of the present apparatus 10, method 50 and system 100 for use with a three phase transmission line leading to an AC grid in a geographically remote location will be discussed. Apparatus 10 will first be described.

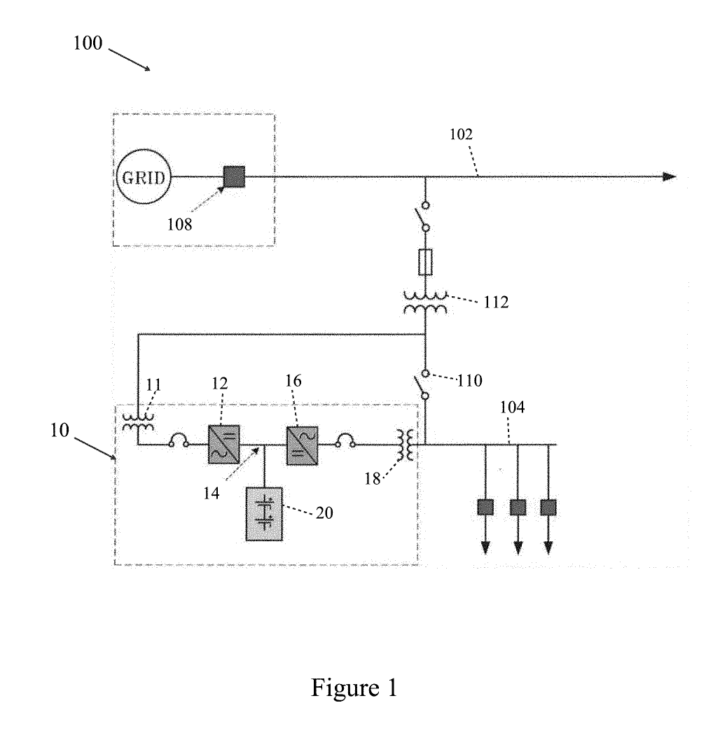

As seen in FIG. 1, apparatus 10 is shown coupled with a three phase transmission line 102 adapted for unbalanced loads leading to an alternating current (AC) grid 104 in a geographically remote location. Apparatus 10 is intended to deliver power having predefined qualities, such as predetermined voltage levels and/or predetermined frequencies. Apparatus 10 includes a first transformer 11, an AC-DC converter system 12, a DC bus 14, a DC-AC converter system 16, and a second transformer 18.

First transformer 11 is configured to receive input AC power or voltage, in the present case, from transmission line 102 at 4,000 V to 50,000 V, and configured to transform the input voltage level down to an operating level, around 600 V.

AC-DC converter system 12 is operatively coupled downstream to first transformer 11 to receive the operating level voltage from first transformer 11. AC-DC converter system 12 is configured to receive input AC power which has one or more phases. AC-DC converter system 12 is further configured to convert the input AC power into direct current (DC) power. In the present embodiment, AC-DC converter system 12 includes multiple rectifiers (not shown), where each of the multiple rectifiers is adapted to receive one of the phases of the input AC power and convert the phase into DC power. AC-DC converter system 12 is designed to be tolerant of both abnormally high and abnormally low input voltages.

DC bus 14 is operatively coupled downstream to AC-DC converter system 12 and includes a lithium ion battery 20. Battery 20 is adapted to receive and store up to 30 minutes of DC power from AC-DC converter system 12.

DC-AC converter system 16 is operatively coupled downstream to DC bus 14 and is adapted to receive DC power from AC-DC converter system 12, from battery 20 or from AC-DC converter system 12 and battery 20. DC-AC converter system 16 is configured to convert the received DC power into AC power. In the present embodiment, DC-AC converter system 16 includes an inverter for converting the DC power into the AC power having three phases and the predefined qualities.

The inverter in the present embodiment is identical in function and features to large scale energy storage inverters except that it is not bi-directional. The inverter provides for voltage and frequency control, and if operated in parallel with other systems, power factor control, active power dispatch, frequency regulation and voltage control.

Second transformer 18 is operatively coupled downstream to DC-AC converter system 16 to receive input AC power having three phases and the predefined qualities. Second transformer 18 transforms the AC voltage having the predefined qualities from the inverter up to a distribution level. Second transformer 18 is also adapted to deliver this distribution level AC power, having the predefined qualities, to remote AC grid 104.

Apparatus 10 may be used in performance of method 50 to distribute energy having predetermined qualities in a geographically remote location from three phase transmission line 102 to remote AC grid 104. The predefined qualities include predetermined voltage levels and/or predetermined frequencies.

At 52, input AC voltage from transmission line 102, having one, two or three phases, is transformed from 4,000 V-50,000 V, down to an operating level, approximately 600 V.

At 54, this transformed AC power is received by AC-DC converter system 12, and at 56, is converted into DC power using multiple rectifiers, such as those found in AC-DC converter system 12. In that regard, each received phase is directed through a separate rectifier for conversion into DC power. In other words, the AC to DC conversion is done on a phase by phase basis so absent phases do not impair the conversion to DC.

At 58, the DC power is optionally used to charge a battery, such as battery 20, in a DC bus. At 60, DC power from AC-DC converter system 12 or battery 20 is converted into AC power having three phases and the predefined qualities using the inverter in DC-AC converter system 16.

In the normal course of use, DC-AC converter system 16 typically receives the DC power from AC-DC converter system 12 when transmission line 102 is in normal working order. In the event of transmission failure of a component of transmission line 102, and power is no longer delivered to AC-DC converter system 12, DC-AC converter system 16 may receive DC power from battery 20 for a limited time. In the shown embodiment, battery 20 has up to 30 minutes of voltage storage capacity. When power resumes to AC-DC converter system 12, DC power from AC-DC converter system 12 may be delivered to recharge battery 20 and delivered to DC-AC converter system 16.

At 62, the AC power having three phases and the predefined qualities may be transformed back up to a distribution level.

At 64, the distribution level AC power with the predefined qualities is sent out to remote AC grid 104.

Apparatus 10 and method 50 may be used in, or as part of, system 100. As shown, apparatus 10 may be located at a load substation 112.

In that regard, system 100 includes apparatus 10, as described above, and a source 108 operatively coupled to, or forming a part of, transmission line 102 upstream of apparatus 10. Source 108 is capable of delivering unbalanced loads and/or unbalanced currents to apparatus 10. In the normal course, source 108 is capable of delivering three phase power therethrough. However, source 108 may at times be a damaged or modified portion of transmission line 102, where inclement weather, a lightning strike or other equipment failure causes one or more of the lines in transmission line 102 to fail. In this manner, only one or two of the standard three phases of power continues to be transmitted through transmission line 102, thereby delivering unbalanced loads or currents to apparatus 10.

As shown, system 100 further includes a bypass switch 110 coupled between source 108 and AC grid 104. Bypass switch 110 is adapted with two configurations: an engaged configuration, where the input AC power from source 108 is directly directed to remote AC grid 104, thereby bypassing apparatus 10, and a disengaged configuration, where the input AC power from source 108 is directed through apparatus 10 before being sent to remote AC grid 104.

In this manner, when the normal three phase power is running through transmission line 102 and the power does not need to be reconstructed though apparatus 10, bypass switch 110 can be engaged to deliver the three-phase power directly to AC grid 104. When only one or two phase power is running through transmission line 102 and the power needs to be reconstructed to be useful, bypass switch 110 can be disengaged to deliver the unbalanced power through apparatus 10 for reconstruction before being sent to AC grid 104. Bypass switch 110 may also be engaged to bypass apparatus 10 when apparatus 10 requires maintenance.

Bypass switch 110 of the present embodiment further includes a local maintenance HMI, lighting, temperature control, auxiliary power, as well as SCADA and relay protection interfaces.

Whereas a specific embodiment is herein shown and described, variations are possible.

In some examples:

automated switches are provided to isolate and ground failed phases,

transformers supplying the potentially unbalanced load are correctly rated for those unbalanced loads,

sky wires are sized to serve as neutral conductors, or

sufficient line capacity must be available for missing phase operation,

the line is modeled to determine line voltages given asymmetric operation.

A potential advantage of the present invention is that it can create three phase power regardless of how many phases of the transmission line are alive, and regardless of the actual voltage on the phases of the line. This allows the line to operated in a “three phase four wire” mode, and capitalize on the inherent triple redundancy of radial three phase lines.

Another potential advantage of the invention is that the power storage in the apparatus allows a continual delivery of power even when the entire line is out, for a limited time, reducing interruption of power delivery to the end users. In that regard, short line maintenance, switching outages and repair of individual phases of the lines can be taken without interrupting power to the end users.

Another potential advantage of the invention is that a wide range of abnormal line voltages may be used as the input AC voltage for reconstruction by the apparatus, method and system into three phase power having the desired predetermined qualities.

Another potential advantage of the invention is that since the voltage and waveform at the load end are synthesized, they may be reconstructed to be within different regulatory limits.

Accordingly, the invention should be understood to be limited only by the accompanying claims, purposively construed.

1. An apparatus for use with (i) a three phase transmission line adapted for unbalanced loads leading to (ii) an alternating current (AC) grid in a geographically remote location, and intended to deliver energy having predefined qualities, the apparatus comprising:
an AC-DC converter system operatively coupled to the transmission line, adapted to receive input AC power having one or more phases delivered by the transmission line and configured to convert the input AC power into direct current (DC) power;
a DC bus and battery adapted to receive and store DC power from the AC-DC converter; and
a DC-AC converter system operatively coupled to, and adapted to receive power from, the AC-DC converter system or the battery, to convert said received power into AC power having the predefined qualities and adapted to deliver the AC power having the predefined qualities to the remote AC grid.

2. The apparatus of claim 1, wherein the AC-DC converter system comprises multiple rectifiers, each of the multiple rectifiers operatively coupled to the transmission line and adapted to receive one of the phases of the input AC power delivered by the transmission line.

3. The apparatus of claim 2, wherein the DC-AC converter system comprises an inverter for converting the DC power into the AC power having the predefined qualities.

4. The apparatus of claim 3, wherein the AC-DC converter system is configured to receive the input AC power having an overall input voltage level from 400V to 50,000V from the transmission line.

5. The apparatus of claim 4, further comprising a first transformer, coupled to the AC-DC converter system, for transforming the input voltage level down to an operating level.

6. The apparatus of claim 5, wherein the inverter is configured to convert the DC voltage into the AC power having three phases.

7. The apparatus of claim 6, wherein the predefined qualities further comprises one or more of predetermined voltage levels and predetermined frequencies.

8. The apparatus of claim 7, further comprising a second transformer coupled to the DC-AC converter system, adapted to transform the AC voltage having the predefined qualities up to a distribution level.

9. A system for use with (i) a three phase transmission line leading to (ii) an alternating current (AC) grid in a geographically remote location, the AC grid intended to deliver energy having predefined qualities, the system comprising:
an apparatus according to any one of claims 1 to 8, and
a source for operative coupling to the transmission line upstream of the apparatus, the source capable of delivering unbalanced loads.

10. The system of claim 9, wherein the source is capable of supplying unbalanced currents.

11. The system of claim 10, further comprising a bypass switch coupled between the source and the AC grid, and adapted to direct the input AC power from the source directly to the AC grid, thereby bypassing the apparatus, when engaged.

12. A method of distributing energy having predetermined qualities in a geographically remote location from a three phase transmission line to a remote AC grid, the method comprising:
receiving input AC power having up to three phases from the transmission line;
converting the input AC power into DC power;
converting the DC power into output AC power having predefined qualities; and
sending the AC power having the predefined qualities to the remote AC grid.

13. The method of claim 12, further comprising charging a DC bus and battery with the DC power prior to converting the DC power into the AC power having the predefined qualities.

14. The method of claim 13, further comprising converting the input AC power into the DC power using multiple rectifiers and converting the DC power into the AC power having the predefined qualities using an inverter.

15. The method of claim 14, wherein the DC power being converted into AC power having the predefined qualities is received from one or more of the multiple rectifiers and the battery.

16. The method of claim 15, wherein the converting of the DC power into output AC power having the predefined qualities comprises converting the DC power into AC power having three phases.

17. The method of claim 16, wherein the predefined qualities of the AC voltage comprises one or more of predetermined voltage levels and predetermined frequencies.
